(19) United States
(12) Patent Application Publication
(10) Pub. No.: US 2006/0118323 A1
(43) Pub. Date: Jun. 8, 2006

(54) Wire harness with concentric code identifier

(76) Inventors: Joseph P. Kalisz, Plymouth, MI (US); James L. Jones III, Belleville, MI (US); Myron U. Trenne, Farmington Hills, MI (US); Vivek Sankar Narayanan, Westland, MI (US)

Correspondence Address: HARNESS, DICKEY & PIERCE, P.L.C., P.O. BOX 828, BLOOMFIELD HILLS, MI, 48303, US

(21) Appl. No.: 11/008,772

(22) Filed: Dec. 8, 2004

(51) Int. Cl. H01B 11/02

(52) U.S. Cl. 174/113 R

(57) ABSTRACT

A wire harness with at least one wire and a connector. The wire can include a conductor and an insulating jacket that can extend along a substantial length of the conductor. The insulating jacket can include one or more code sections that are permanently marked onto the insulating jacket. Each code section can have a plurality of stripes that can extend about at least a portion of a perimeter of the insulating jacket. The code sections can be spaced apart by from one another and can include manufacturing data, such as a lot number or date of manufacture, and/or engineering data, such as a circuit designation, a wire size, a wire length, a wire location, and/or a termination point. A method for forming a wire harness is also provided.

The present invention generally relates to wire harnesses and more particularly to a wire harness that employs one or more concentric code identifiers, such as bar codes, to identify a given conductor or circuit.

A modern automotive wire harnesses typically employs tens of individual circuits, with each circuit comprising one or more discrete wire components. Frequently, each of the wire components has an insulative jacket that is color coded so as to identify the circuit and/or the specific wire component. The drawbacks that are associated with the construction of wire harnesses in this manner are well documented.

For example, manufacturers of wire harnesses must have a ready supply of numerous spools of differently colored wire. In addition to concerns about the size of their inventory of wire, there are also concerns for the speed with which the inventory is consumed. In this regard, some color combinations of the wire are frequently used, while other color combinations are only infrequently used and tend to sit in inventory for extended periods of time.

Another drawback concerns the difficulty of reading the color codes. In some situations, particularly where the wire size is relatively small (i.e., high gauge wire, such as 18, 20 or 22 AWG), it can be difficult to distinguish the base color of the wire (e.g., is it a red stripe on black background or a black stripe on a red background?). Moreover, color codes can be difficult to read for those who are have some form of color blindness.

### SUMMARY

In one form, the present teachings provide a wire harness that includes a wire and a connector. The wire includes a conductor and an insulating jacket that extends along a substantial length of the conductor. The insulating jacket includes at least two code sections that are permanently marked onto the insulating jacket, with each code section having a plurality of stripes that extend about at least a portion of a perimeter of the insulating jacket. The code sections are spaced apart by a predetermined distance. The connector has a terminal that is electrically coupled to the conductor.

In another form, the present teachings provide a method that includes: providing a first wire with first conductor and a first insulating jacket that extends along a substantial length of the first conductor; providing a second wire with a second conductor and a second insulating jacket that extends along a substantial length of the second conductor; marking the first insulating jacket with a first set of code sections, each of the code sections of the first set of code sections being permanently marked onto the first insulating jacket and having a plurality of stripes that extend about a portion of a circumference of the first insulating jacket; marking the second insulating jacket with a second set of code sections, each of the code sections of the second set of code sections being permanently marked onto the second insulating jacket and having a plurality of stripes that extend about a portion of a circumference of the second insulating jacket; and coupling a connector to the first and second wires, the connector having a first terminal that is electrically coupled to the first conductor and a second terminal that is electrically coupled to the second conductor.

In yet another form, the present teachings provide a wire harness that includes a plurality of wires, each of which having a conductor and an insulating jacket that surrounds the conductor over a substantial portion of a length of the conductor. The insulating jackets of the wires are permanently marked with a code section having a plurality of stripes that extend at least partially about the perimeter thereof. Each of the code sections identifies at least one of a circuit designation, a wire size, a wire length, a wire location, and a termination point that is associated with a corresponding one of the wires

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a wire harness constructed in accordance with the teachings of the present invention; and

FIG. 2 is a perspective view of a portion of the wire harness of FIG. 1 illustrating an individual wire segment in greater detail.

### DETAILED DESCRIPTION OF THE VARIOUS EMBODIMENTS

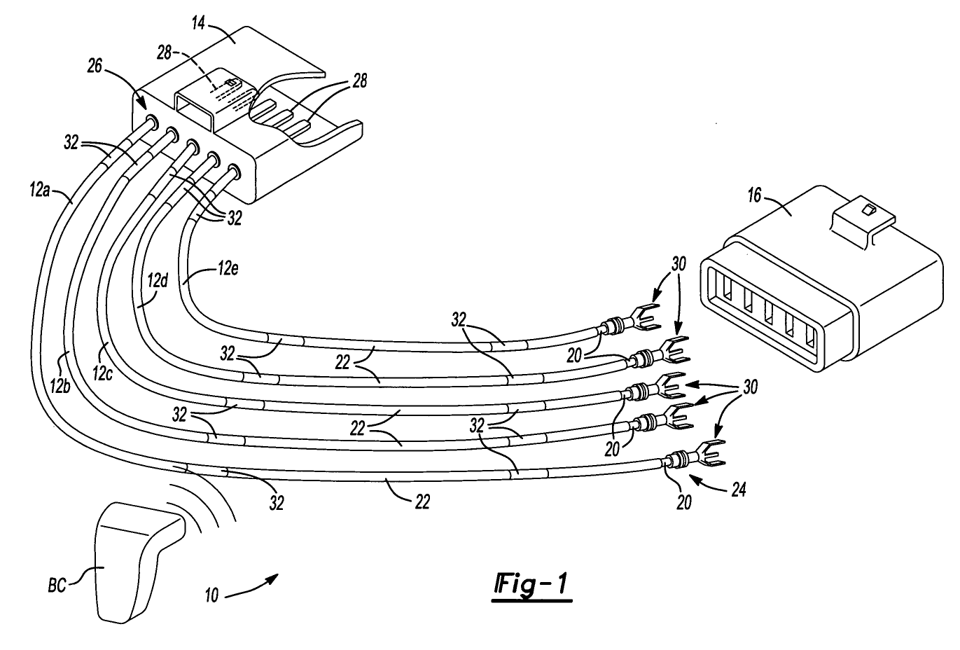

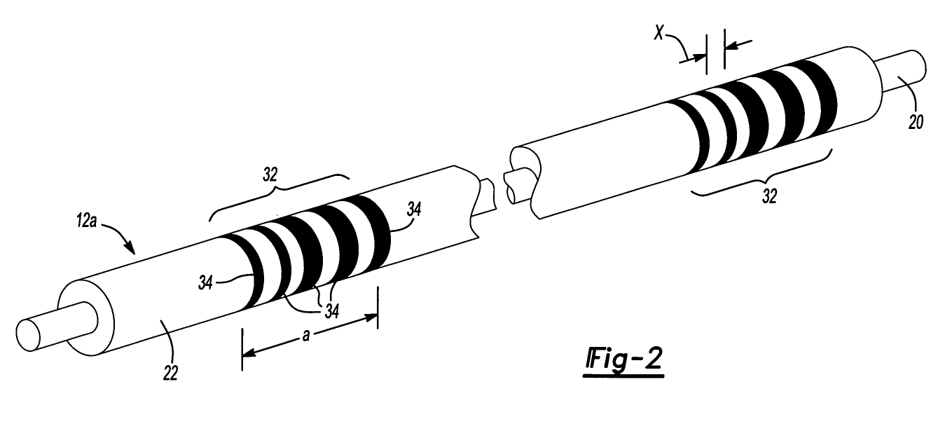

With reference to FIGS. 1 and 2 of the drawings, a wire harness constructed in accordance with the teachings of the present invention is generally indicated by reference numeral 10. The wire harness 10 can include a plurality of wires 12a, 12b, 12c, 12d, 12e and one or more connectors 14, 16 that may be coupled to one or more of the wires.

In the example provided, each of the wires is generally similar in its construction and as such, only the wire 12a will be discussed in detail. The wire 12a can include a conductor 20 and an insulating jacket 22. The conductor 20 is formed of an electrically conductive material, such as copper, and can extend between a pair of termination points 24 and 26. In the particular example provided, the conductor 20 is electrically coupled to a first terminal 28 that is housed by the connector 14 at the termination point 24, while the conductor 20 is electrically coupled to a second terminal 30 that is housed by the connector 16 at the second termination point 26.

The insulating jacket 22 is an electrically insulating material that extends about the conductor 20 for a substantial length of the conductor 20. Typically, the insulating jacket 22 will cover all but a small segment of the conductor 20 that is located each of the termination points 24 and 26. Also typically, the insulating jacket 22 has a circular cross-section, but those of ordinary skill in the art will appreciate that insulating jackets of various other shapes may be used as well.

As noted above, in a conventional wire harness, the insulation of the individual wire segments is color coded to aid one to identify the particular wire segment or a circuit in which the wire segment is located. While a wire harness 10 constructed in accordance with the teachings of the present invention may utilize color-coding in a conventional manner, the wires 12a, 12b, 12c, 12d, 12e either additionally or alternatively include one or more code sections 32.

Each of the code sections 32 is permanently marked onto the insulating jacket 22 of a corresponding wire and can comprise a plurality of stripes 34 that extend about at least a portion of the perimeter of the insulating jacket 22. Any appropriate means may be employed to apply the code section 32 to the insulating jacket 22, including ink jet printers, roll dies (stamps), and hot stamps, for example. While in its most basic form the stripes 34 that make up a code section 32 may be directly read by a technician, devices such as bar code scanners BC may be employed to expeditiously and accurately read the code section 32. In such situations, it may be desirable that the stripes 34 extend about a majority of the perimeter of the insulating jacket 22 to permit the bar code scanner to read the code section 32 without the need to rotate the wire. In such situations, it may be preferable that the code sections 32 extend completely about the perimeter of the insulating jacket 22. It will be appreciated that the width “x” and/or number of the stripes may vary depending upon how information is encoded in the code section. In the particular example provided, each of the code sections 32 has predetermined length of a dimension “a”.

It will be appreciated that various types of information may be encoded into the code section 32. In this regard, the code section 32 can include a circuit designation or number identifying the circuit in which the associated wire is disposed, the size of the conductor (e.g., AWG wire size), the location of the wire, the termination point or points of the wire and/or manufacturing data, such as a date of manufacture (of either the wire segment or the wire harness), the plant of manufacture (of either the wire segment of the wire harness), and/or a manufacturing lot number.

In some situations, it may be desirable to mark two or more identical code sections 32 on the insulating jacket 22 that may be spaced apart by a predetermined distance. For example, the insulating jacket 22 of one or more of the wires 12a, 12b, 12c, 12d, 12e may be marked at locations proximate the termination points 24 and 26. As another example, the insulating jacket 22 of one or more of the wires 12a, 12b, 12c, 12d, and 12e may be marked at three or more locations along the length of the wire, with each location being spaced apart from another at a desired interval.

From the foregoing, those of ordinary skill in the art will appreciate that the coding of one or more of the wires of a wire harness in the manner described above can provide a means for identifying individual wires and circuits. Color-coding of the individual wires may be omitted so that insulating jackets of substantially the same color may be used for the several wires without adversely affecting the capacity of a technician to identify individual wire elements and circuits.

While the invention has been described in the specification and illustrated in the drawings with reference to a particular embodiment, it will be understood by those skilled in the art that various changes may be made and equivalents may be substituted for elements thereof without departing from the scope of the invention as defined in the claims. Furthermore, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.
What is claimed is:

1. A wire harness comprising:
a wire and a connector, the wire including a conductor and an insulating jacket that extends along a substantial length of the conductor, the insulating jacket including at least two code sections that are permanently marked onto the insulating jacket, each code section having a plurality of stripes that extend about at least a portion of a perimeter of the insulating jacket, the code sections being spaced apart from one another, the connector having a terminal that is electrically coupled to the conductor.

2. The wire harness of claim 1, wherein the code sections extend about a majority of the circumference of the insulating jacket.

3. The wire harness of claim 1, wherein the code sections extend completely about the circumference of the insulating jacket.

4. The wire harness of claim 1, wherein the code sections are identical and each of the code sections includes at least one of a circuit designation, a wire size, a wire length, a wire location, and a termination point.

5. The wire harness of claim 1, wherein at least one of the code sections includes a set of manufacturing data.

6. The wire harness of claim 5, wherein the set of manufacturing data includes at least one of a manufacturing plant, a lot number and a date of manufacture.

7. The wire harness of claim 1, further comprising a second wire having a second conductor and a second insulating jacket that extends along a substantial length of the second conductor, the second insulating jacket including at least two code sections that are permanently marked onto the second insulating jacket, each code section on the second insulating jacket having a plurality of stripes that extend about at least a portion of a perimeter of the second insulating jacket, the code sections on the second insulating jacket being spaced apart from one another.

8. The wire harness of claim 7, wherein the insulating jacket and the second insulating jacket are substantially the same color.

9. The wire harness of claim 7, wherein the second insulating jacket has a generally circular cross-section.

10. The wire harness of claim 1, wherein the insulating jacket has a generally circular cross-section.

11. A method comprising:
providing a first wire with first conductor and a first insulating jacket that extends along a substantial length of the first conductor;
providing a second wire with a second conductor and a second insulating jacket that extends along a substantial length of the second conductor;
marking the first insulating jacket with a first set of code sections, each of the code sections of the first set of code sections being permanently marked onto the first insulating jacket and having a plurality of stripes that extend about a portion of a circumference of the first insulating jacket;
marking the second insulating jacket with a second set of code sections, each of the code sections of the second set of code sections being permanently marked onto the second insulating jacket and having a plurality of stripes that extend about a portion of a circumference of the second insulating jacket;
coupling a connector to the first and second wires, the connector having a first terminal that is electrically coupled to the first conductor and a second terminal that is electrically coupled to the second conductor.

12. The method of claim 11, wherein at least one of the code sections identifies at least one of a circuit designation, a wire size, a wire length, a wire location, and a termination point.

13. The method of claim 11, wherein at least one of the code sections includes a set of manufacturing data.

14. The method of claim 13, wherein the set of manufacturing data includes at least one of a manufacturing plant, a lot number and a date of manufacture.

15. A wire harness comprising a plurality of wires, each of the wires including a conductor and an insulating jacket that surrounds the conductor over a substantial portion of a length of the conductor, the insulating jackets of the wires being permanently marked with a code section having a plurality of stripes that extend at least partially about the perimeter thereof, each of the code sections identifying at least one of a circuit designation, a wire size, a wire length, a wire location, and a termination point that is associated with a corresponding one of the wires.
